(19) United States
(12) Patent Application Publication
(10) Pub. No.: US 2008/0022101 A1
(43) Pub. Date: Jan. 24, 2008

(54) Data transmission method and apparatus

(75) Inventors: Hyun-ah Sung, Gwanak-gu (KR); Se-hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/716,629

(22) Filed: Mar. 12, 2007

(30) Foreign Application Priority Data
Jul. 19, 2006 (KR) 10-2006-0067304

(51) Int. Cl. H04L 9/00

(52) U.S. Cl. 713/171

(57) ABSTRACT

A method and apparatus for data transmission are provided. The method includes receiving, at a first device, information used for security of data transmission from a second device using Radio Frequency Identification (RFID); and transmitting data from the first device to the second device based on the received information. The apparatus includes a security information receiver which receives information used for security of data transmission from a device using Radio Frequency Identification (RFID); and a data transmitter which transmits data to the device based on the received information.

### CROSS-REFERENCE TO RELATED PATENT APPLICATION

This application claims priority from Korean Patent Application No. 10-2006-0067304, filed on Jul. 19, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to securely transmitting data, and more particularly, to securely transmitting data between home network devices.

2. Description of the Related Art

Since data communication performed via a wired or wireless network is performed remotely, data is exposed to a security risk. The security risk, such as hacking or eavesdropping by a device which is not authorized to transmit or receive data always exists. In particular, when data must be transmitted or received by only authorized devices since the data is confidential data, a method of guaranteeing security of data communication is needed.

A related art security method used to remove the security risk is a communication method using a security key, i.e., a method of encrypting data using the security key and decrypting the encrypted data by only a device having the security key, and the method can be used between devices connected to each other in a wired or wireless network.

A symmetric or asymmetric key scheme is used as an algorithm for generating a security key. The symmetric key scheme is a method for a data transmitting device and a data receiving device to encrypt and decrypt data using the same security key. The asymmetric key scheme is a method in which an encryption key used for encryption of data is different from a decryption key used for decryption of the encrypted data. In general, since the asymmetric key scheme takes a longer time for encryption and decryption as compared to the symmetric key scheme, the two schemes are combined and used as described below.

FIG. 1 is a signaling diagram illustrating a related art public key communication method.

Referring to FIG. 1, in operation 101, a transmission device 11 for transmitting data receives a public key transmitted from a reception device 12. A private key, which forms a pair with the public key and is used for decryption, is known by only the reception device 12 and not known to any other device.

In operation 102, the transmission device 11 encrypts a symmetric key, which is used for encryption and decryption of data to be transmitted, using the public key received in operation 101. Since only the private key forming a pair with the public key can be used for decryption of the symmetric key encrypted using the public key, only the reception device 12 can know the symmetric key used by the transmission device 11.

In operation 103, the transmission device 11 transmits the symmetric key encrypted in operation 102 to the reception device 12. Since the symmetric key encrypted using the public key can be decrypted using the private key by only the reception device 12, even if another device sniffs or eavesdrops the encrypted symmetric key during the transmission, the encrypted symmetric key cannot be decrypted, and thereby, security of the data communication is guaranteed.

In operation 104, the reception device 12 generates the symmetric key by decrypting the encrypted symmetric key, which has been received from the transmission device 11, using the private key.

In operation 105, when the transmission device 11 confirms that the reception device 12 has received the encrypted symmetric key, the transmission device 11 encrypts data using the symmetric key and transmits the encrypted data to the reception device 12. Since the symmetric key known by the reception device 12 is the same as the symmetric key used for the data encryption by the transmission device 11, the reception device 12 can decrypt the received data.

However, the related art communication method illustrated in FIG. 1 has a problem in that when a device, which is not authorized to receive data, transmits a public key to the transmission device 11 by disguising itself as the reception device 12 and receives data from the transmission device 11 in operations 101 through 105, the transmission device 11 cannot distinguish the unauthorized device from the reception device 12. Likewise, if a device, which is not authorized to transmit data, transmits a symmetric key using a public key transmitted by the reception device 12 and finally transmits data by disguising itself as the transmission device 11, the reception device 12 cannot distinguish the unauthorized device from the transmission device 11. Thus, to prevent these problems, a public key infrastructure (PKI) includes a separate verification authority for guaranteeing that a public key is transmitted by an authorized reception device and that an authorized transmission device transmits data.

However, if a verification process of the verification authority is performed every time home network devices perform data communication, time is wasted. In addition, it is inappropriate to maintain a separate verification authority for a home network, which is generally a small-sized network.

Thus, a method and apparatus for performing secured data communication without a verification authority while guaranteeing an authorized transmission or reception device would be advantageous.

### SUMMARY OF THE INVENTION

The present invention provides a method and apparatus for securely transmitting data.

The present invention also provides a computer readable recording medium storing a computer readable program for executing the method.

According to an aspect of the present invention, there is provided a data transmission method comprising receiving, at a first device, information used for security of data transmission from a second device using Radio Frequency Identification (RFID); and transmitting data from the first device to the second device based on the received information.

The information may be a public key of the second device.

The transmitting of the data may comprise generating a symmetric key; encrypting the symmetric key using the public key of the second device; transmitting the symmetric key to the second device; and transmitting the encrypted data to the second device.

According to another aspect of the present invention, there is provided a data transmission method comprising transmitting, from a second device, information used for security of data reception to a first device using Radio Frequency Identification (RFID); and receiving, at the second device, data transmitted by the first device based on the information.

The information may be a public key of the device.

According to another aspect of the present invention, there is provided an apparatus comprising a security information receiver which receives information used for security of data transmission from a device using Radio Frequency Identification (RFID); and a data transmitter which transmits data to the device based on the received information.

The information may be a public key of the device.

According to another aspect of the present invention, there is provided an apparatus comprising a security information transmitter which transmits information used for security of data reception to a device using Radio Frequency Identification (RFID); and a data receiver which receives data transmitted by the device based on the information.

The information may be information used for security of data reception.

The information may be a public key of the second device.

### BRIEF DESCRIPTION OF THE DRAWINGS

FIG. 1 is a signaling diagram illustrating a related art public key communication method;

FIGS. 2A and 2B are signaling diagrams illustrating a data transmission and reception method according to an exemplary embodiment of the present invention;

FIG. 3 is a signaling diagram illustrating a data transmission and reception method according to another exemplary embodiment of the present invention;

FIGS. 4A and 4B are block diagrams of a data transmission apparatus according to an exemplary embodiment of the present invention; and

FIGS. 5A and 5B are block diagrams of a data reception apparatus according to an exemplary embodiment of the present invention.

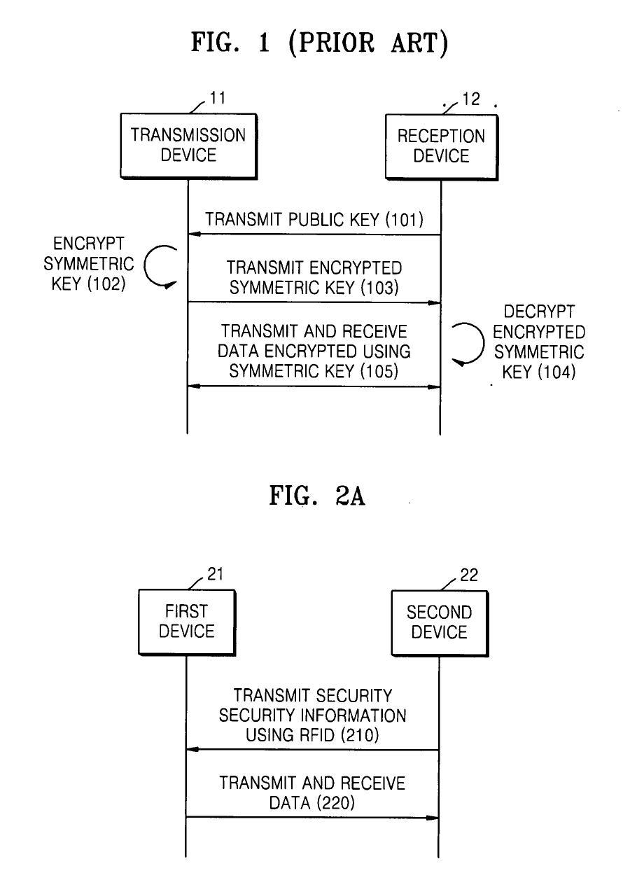

### DETAILED DESCRIPTION OF EXEMPLARY EMBODIMENTS OF THE INVENTION

A Radio Frequency Identification (RFID) system is a radio recognition system for recognizing a target object and acquiring information using a radio frequency and an integrated circuit (IC) chip. A RFID system is generally comprised of an RFID tag and an RFID reader. An RFID method is a method for an RFID reader to read data stored in an IC chip attached to an RFID tag using a radio frequency in a non-contact manner.

An RFID tag is classified into an active tag and a passive tag according to whether a battery is included therein. The active tag operating by receiving power from the battery included therein is an RFID tag for reading and writing data.

Near Field Communication (NFC) is a wireless communication technique in which a non-contact verification technique and an ad-hoc networking technique are combined based on the RFID technology. A user can perform various kinds of data communication by moving an NFC tag close to an NFC device without a complex environment setting process. The NFC is a kind of short-range wireless communication for transmitting data with low power within a distance of 10 cm using a frequency of about a 13.56 MHz band. By using the NFC, a device, such as an audio/video (AV) device, a digital camera, a personal digital assistant (PDA), a set-top box, or the like, can transmit data at a high speed to another device without a user's operation.

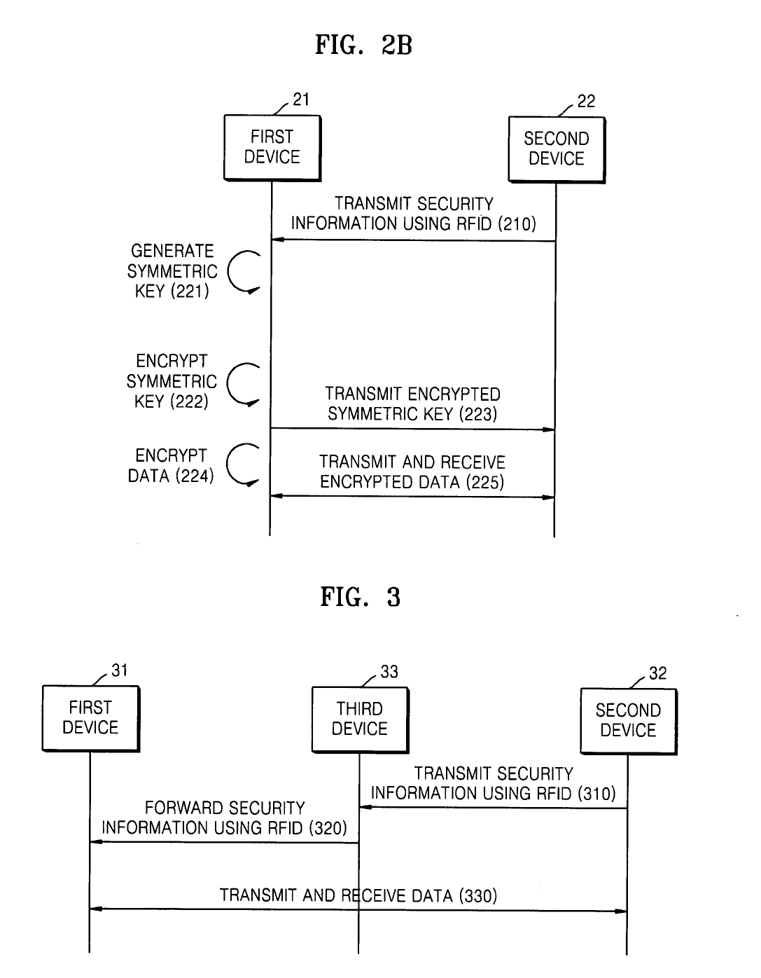

FIGS. 2A and 2B are signaling diagrams illustrating a method of securely transmitting and receiving data according to an exemplary embodiment of the present invention.

In FIGS. 2A and 2B, it is assumed that a first device 21 and a second device 22 belong to a single network, wherein the first device 21 transmits data to the second device 22.

Referring to FIG. 2A, in operation 210, the first device 21 receives information used for secure data communication with the second device 22 from the second device 22, which transmits the information used for secure data communication to the first device. According to the current exemplary embodiment, the information used for security is transmitted from an RFID tag included in the second device 22 to an RFID reader included in the first device 21. If the first device 21 and the second device 22 are close enough to each other so as to be within a recognizable distance from each other, information transmission is achieved without a separate user's operation. The recognizable distance may be predetermined. Since the information used for security is transmitted and received between only adjacent devices, i.e., devices which are physically close together, security of the data communication between the first device 21 and the second device 22 is guaranteed. According to the current exemplary embodiment, the RFID tag and the RFID reader used for transmitting the information used for security are a tag and a reader according to an NFC standard.

The information used for secure communication, which the first device 21 receives from the second device 22, includes a public key used for security according to a public key method. The public key is used to produce a symmetric key which is, in turn, used for the first device 21 to encrypt data to be transmitted.

The information used for security, which the first device 21 receives from the second device 22, can include information on an Internet Protocol (IP)-based address, a non-IP-based address, or a channel allocated to data communication instead of the public key. The non-IP-based address corresponds to a Media Access Control (MAC) address or a device identifier (ID) allocated to the second device 22 in the home network. A device for data communication can be selected by informing only the first device 21 of an IP-based address or non-IP-based address of the second device 22 using RFID. The second device 22 informs only the first device 21 of information on a channel to be used for the data communication using RFID.

In operation 220, data is transmitted to the second device 22 based on the information used for security, which has been transmitted to the first device 21 in operation 210. In this case, only the information used for security of data communication of operation 210 is transmitted using RFID, and the data communication of operation 220 is performed using a wired or wireless network having a higher data rate than that of the RFID. The wired or wireless network can be a wired network of the home network or a wireless network such as Bluetooth or Wireless Local Area Network (WLAN).

If the information used for security, which is received by the first device 21 in operation 210 is a public key, in operation 220, the first device 21 performs operations 221 through 225 illustrated in FIG. 2B.

Referring to FIG. 2B, in operation 221, the first device 21 generates a symmetric key. The symmetric key is a security key used to encrypt the data to be transmitted from the first device 21 to the second device 22.

In operation 222, the first device 21 encrypts the symmetric key generated in operation 221 using the public key received in operation 210. Since the symmetric key must be open to only the first device 21 and the second device 22, the symmetric key is encrypted using the public key so that only the second device 22 can decrypt the encrypted symmetric key using a private key forming a pair with the public key.

If all data transmitted from the first device 21 to the second device 22 is encrypted using the public key, it takes a long time to decrypt the encrypted data using the private key, and thus, only the symmetric key is encrypted using the public key, and transmitted to the second device 22.

In operation 223, the first device 21 transmits the symmetric key, which is encrypted using the public key of the second device 22 in operation 222, to the second device 22.

When the second device 22 receives the encrypted symmetric key, in operation 224, the first device 21 encrypts the data to be transmitted to the second device 22 using the symmetric key generated in operation 221.

In operation 225, first device 21 transmits and receives the data encrypted using the symmetric key in operation 224 to the second device 22.

FIG. 3 is a signaling diagram illustrating a method of securely transmitting and receiving data according to another exemplary embodiment of the present invention. As illustrated in FIGS. 2A and 2B, it is assumed that a first device 31 and a second device 32 belong to a single network, wherein the first device 31 transmits data to the second device 32.

However, the method illustrated in FIG. 3 is different from the method illustrated in FIGS. 2A and 2B in that since a distance between the first device 31 and the second device 32 is too far to directly transmit and receive information used for secure communication using RFID, the information used for security is transferred using a third device 33. That is, if the first device 31 and the second device 32 cannot be easily moved, such as a digital TV (DTV) and a desktop personal computer (PC) and thus cannot directly transmit and receive predetermined information using RFID, the information used for security is transferred using the third device 33, which is easily moved.

Thus, the third device 33 includes an RFID reader, which can receive information transmitted from an RFID tag, and an RFID tag, which can transmit the information received from the second device 32 using the RFID reader to the first device 31.

Referring to FIG. 3, in operation 310, the third device 33 receives information used for security of data communication between the first device 31 and the second device 32 from the second device 32. According to the current exemplary embodiment, the third device 33 receives the information used for security from an RFID tag included in the second device 32 using the RFID reader included therein.

As described above with reference to the exemplary embodiment shown in FIGS. 2A and 2B, the information received by the third device 33 can include information on a public key used for the public key method, an IP-based address, a non-IP-based address, or a channel allocated to a link.

In operation 320, the third device forwards the security information using the RFID. That is, the first device 31 receives the information used for security, which has been transmitted from the second device 32 to the third device 33 in operation 310, from the third device 33.

In operations 310 and 320, the third device 33 receives the information used for security from the adjacent second device 32, and the third device 33 moves close to the first device 31, and transmits the information used for security to the first device 31. Thus, the information used for security of data communication between the first device 31 and the second device 32 is transmitted from the second device 32 to the first device 31, via the third device 33.

According to the current exemplary embodiment, the RFID tag and the RFID reader used for transmitting the information used for security in operations 310 and 320 are a tag and a reader according to the NFC standard.

In operation 330, the first device 31 transmits data to the second device 32 based on the information used for security, which has been transmitted to the first device 31 in operations 310 and 320. Only the information used for security of data communication of the operations 310 and 320 is transmitted using RFID, and the data communication of operation 320 is performed using a wired or wireless network having a higher data rate than that of the RFID. The wired or wireless network can be a wired network of the home network or a wireless network such as a Bluetooth WPAN or a WLAN.

If the information used for security, which is received by the first device 31 in operations 310 and 320 is a public key of the second device 32, the first device 31 performs the same operations as operations 221 through 225 illustrated in FIG. 2B.

In other words, the first device 31 generates a symmetric key used to encrypt data to be transmitted to the second device 32, encrypts the symmetric key using the public key of the second device 32, and transmits the encrypted symmetric key to the second device 32. Then, the first device 31 encrypts data using the generated symmetric key and transmits the encrypted data to the second device 32.

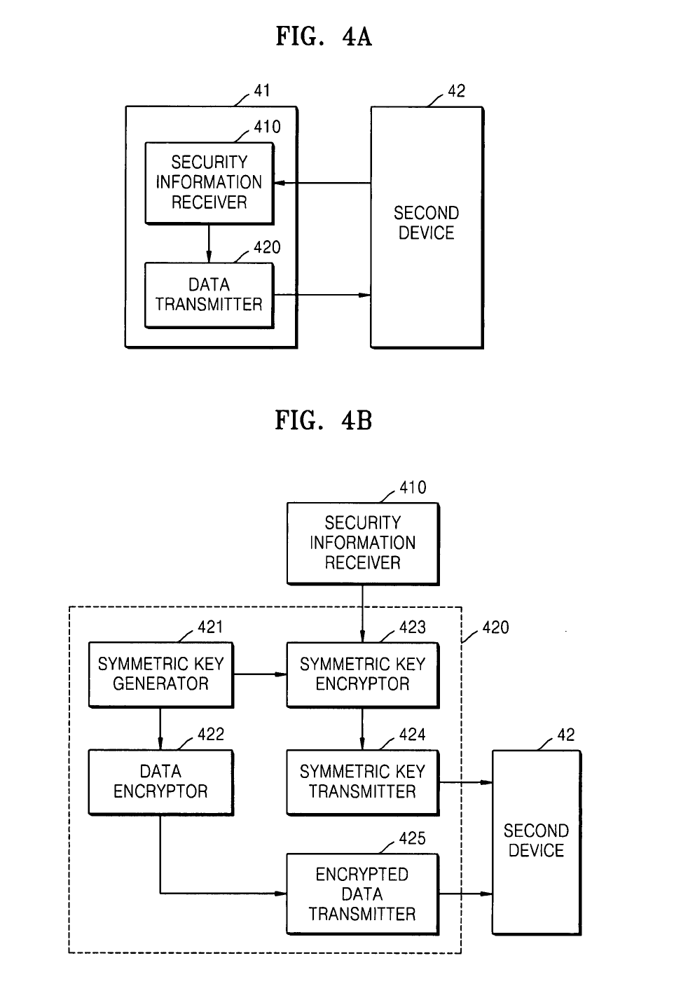

FIGS. 4A and 4B are block diagrams of an apparatus for safely transmitting data according to an exemplary embodiment of the present invention.

Referring to FIG. 4A, a data transmission apparatus of a first device 41 according to an exemplary embodiment of the present invention includes a security information receiver 410 and a data transmitter 420. The first device 41 is a data transmission device, and a second device 42 is a device receiving data transmitted by the data transmission apparatus of the first device 41.

The security information receiver 410 receives information used for secure data communication from the second device 42. The information used for security includes information on a public key, an IP-based address, a non-IP-based address, or a channel allocated to the data communication of the second device 42. Since the information used for security transmitted by the second device 42 can be received by only an adjacent device using RFID, security of the data communication can be guaranteed.

If the first device 41 cannot directly receive the information used for security from the second device 42 using RFID, an exemplary embodiment of the present invention can be configured so that a third device (not shown) receives the information used for security from the second device 42 using RFID and transmits the information used for security to the first device 41 using RFID. This corresponds to a case where a physical distance between the first device 41 and the second device 42 is too far to directly transmit and receive information using RFID and the first device 41 and the second device 42 cannot be moved to be close to each other.

The data transmitter 420 transmits data to the second device 42 based on the information used for security, which has been received by the security information receiver 410. In this case, the data is transmitted based on an address of the second device 42 or a channel allocated for the data communication with the second device 42.

Referring to FIG. 4B, if the information used for security received by the security information receiver 410 is the public key of the second device 42, the data transmitter 420 includes a symmetric key generator 421, a data encryptor 422, a symmetric key encryptor 423, a symmetric key transmitter 424, and an encrypted data transmitter 425.

The symmetric key generator 421 generates a symmetric key used to encrypt data to be transmitted to the second device 42.

The data encryptor 422 encrypts the data to be transmitted to the second device 42 using the symmetric key generated by the symmetric key generator 421. If the data to be transmitted is encrypted using the public key of the second device 42, encryption and decryption takes a longer time as compared to encryption using the symmetric key, and thus, the data to be transmitted is encrypted using the symmetric key.

The symmetric key encryptor 423 encrypts the symmetric key generated by the symmetric key generator 421 using the public key, which has been received by security information receiver 410 from the second device 42. As described above, only the symmetric key is encrypted using the public key, and the data to be transmitted to the second device 42 is encrypted using the symmetric key.

The symmetric key transmitter 424 transmits the symmetric key, which has been encrypted by the symmetric key encryptor 423 using the public key of the second device 42, to the second device 42. Since the symmetric key is encrypted using the public key of the second device 42, the second device 42 can decrypt the encrypted symmetric key using a private key which forms a pair with the public key.

The encrypted data transmitter 425 transmits the data, which has been encrypted by data encryptor 422 using the symmetric key, to the second device 42. Since the symmetric key is open to only the second device 42, even if a device, which is not authorized, sniffs or eavesdrops the encrypted data, the device cannot decrypt the encrypted data. Thus, security of the data communication can be guaranteed.

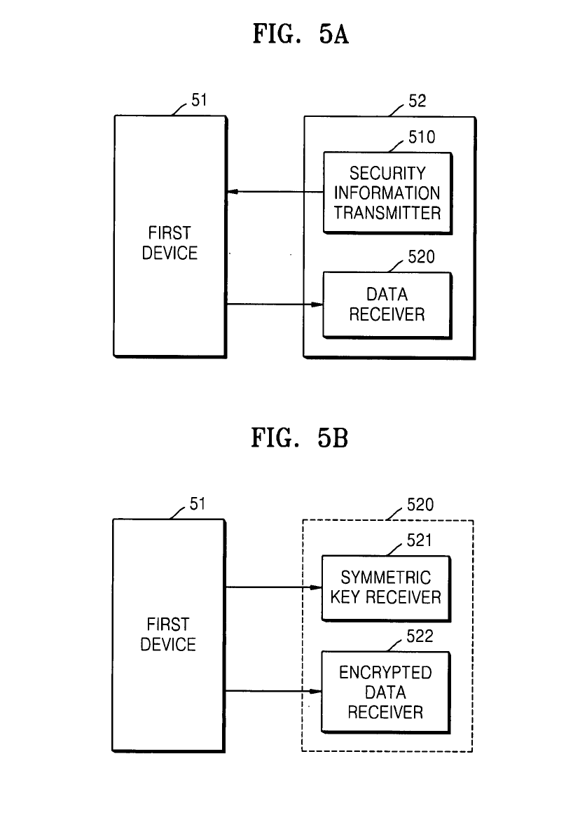

FIGS. 5A and 5B are block diagrams of an apparatus for safely receiving data according to another exemplary embodiment of the present invention.

Referring to FIG. 5A, a data receiving device of a second device 52 according to another exemplary embodiment of the present invention includes a security information transmitter 510 and a data receiver 520. A first device 51 is a device for transmitting data, and the second device 52 is a device for receiving the data, which is transmitted by a data transmitting device of the first device 51. The data may be predetermined.

The security information transmitter 510 transmits information used for security of data communication to the first device 51. As described above, the information used for security of data communication includes information on a public key, an IP-based address, a non-IP-based address, or a channel allocated to the data communication of the second device 52.

If the first device 51 cannot directly receive the information used for security from the second device 52 using RFID, an exemplary embodiment of the present invention can be configured so that a third device (not shown) receives the information used for security from the second device 52 using RFID and transmits the information used for security to the first device 51 using RFID. This corresponds to a case where a physical distance between the first device 51 and the second device 52 is too far to directly transmit and receive information using RFID and the first device 51 and the second device 52 cannot be moved to be close enough to each other to transmit and receive using RFID.

The data receiver 520 receives data transmitted by the first device 51 based on the information used for security, which has been transmitted by the security information transmitter 510.

Referring to FIG. 5B, if the information used for security, which has been transmitted by the security information transmitter 510 is the public key of the second device 52, the data receiver 520 includes a symmetric key receiver 521 and an encrypted data receiver 522.

The symmetric key receiver 521 receives a symmetric key encrypted using the public key, which has been transmitted to the first device 51 by the security information transmitter 510. As described above, if data is encrypted using the public key, encryption and decryption takes a longer time, and thus, the first device 51 encrypts only the symmetric key using the public key and transmits the encrypted symmetric key, and the symmetric key receiver 521 receives the encrypted symmetric key.

The encrypted data receiver 522 receives data encrypted using the symmetric key from the first device 51. Since the symmetric key has been encrypted using the public key of the second device 52, the encrypted symmetric key can be decrypted using a private key which forms a pair with the public key. Since the private key is known by only the second device 52, the data encrypted using the symmetric key can be decrypted by only the second device 52, and thus, security of the data communication can be guaranteed.

The present inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to exemplary embodiments of the present invention, since information used for secure communication is transmitted and received between devices which are within a close physical proximity of each other, i.e., adjacent to each other, using a non-contact short-range wireless communication method and data is transmitted based on the information used for security, security of the data communication can be guaranteed.

While the present inventive concept has been particularly shown and described with reference to certain exemplary embodiments thereof, it will be understood by those of ordinary skill in the art that various changes in form and detail may be made therein without departing from the spirit and scope of the present invention as defined by the following claims.

What is claimed is:

1. A data transmission method comprising:
receiving, at a first device, information used for security of data transmission from a second device using Radio Frequency Identification (RFID); and
transmitting data, from the first device, to the second device based on the received information.

2. The data transmission method of claim 1, wherein the information is a public key of the second device.

3. The data transmission method of claim 2, wherein the transmitting the data comprises:
generating a symmetric key;
encrypting the symmetric key using the public key of the second device;
transmitting the encrypted symmetric key to the second device;
encrypting the data using the symmetric key; and
transmitting the encrypted data to the second device.

4. The data transmission method of claim 1, wherein the information is information on an Internet Protocol (IP)-based address, a non-IP-based address, or a channel, which is allocated to transmit the data, of the second device.

5. The data transmission method of claim 1, wherein the receiving the information comprises receiving the information from a third device,
wherein the third device is a device which receives the information from the second device using RFID in order to transmit the information to the first device.

6. The data transmission method of claim 5, wherein the RFID is based on a Near Field Communication (NFC) standard.

7. A data transmission method comprising:
transmitting, from a second device, information used for security of data reception to a first device using Radio Frequency Identification (RFID); and
receiving, at the second device, data transmitted by the first device based on the information.

8. The data transmission method of claim 7, wherein the information is a public key of the second device.

9. The data transmission method of claim 8, wherein the receiving the data comprises:
receiving a symmetric key, which is encrypted using the public key of the second device, from the first device; and
receiving the data encrypted using the symmetric key.

10. The data transmission method of claim 7, wherein the information is information on an Internet Protocol (IP)-based address, a non-IP-based address, or a channel, which is allocated to receive the data, of the second device.

11. The data transmission method of claim 7, wherein the transmitting the information comprises transmitting the information to a third device,
wherein the third device is a device which transmits the information, which has been received from the second device, to the first device using RFID.

12. The data transmission method of claim 5, wherein the RFID is based on a Near Field Communication (NFC) standard.

13. An apparatus comprising:
a security information receiver which receives information used for security of data transmission from a device using Radio Frequency Identification (RFID); and
a data transmitter which transmits data to the device based on the received information.

14. The apparatus of claim 13, wherein the information is a public key of the device.

15. The apparatus of claim 14, wherein the data transmitter comprises:
a symmetric key generator which generates a symmetric key;
a symmetric key encryptor which encrypts the symmetric key using the public key of the device;
a symmetric key transmitter which transmits the encrypted symmetric key to the device;
a data encryptor which encrypts the data using the symmetric key; and
an encrypted data transmitter which transmits the encrypted data encrypted to the device.

16. The apparatus of claim 13, wherein the RFID is based on a Near Field Communication (NFC) standard.

17. An apparatus comprising:
a security information transmitter which transmits information used for security of data reception to a device using Radio Frequency Identification (RFID); and
a data receiver which receives data transmitted by the device based on the information.

18. The apparatus of claim 17, wherein the information is a public key of the device.

19. The apparatus of claim 18, wherein the data receiver comprises:
a symmetric key receiver which receives a symmetric key encrypted using the public key; and
an encrypted data receiver which receives the data encrypted using the symmetric key.

20. The apparatus of claim 16, wherein the RFID is based on a Near Field Communication (NFC) standard.
